(19) United States
(12) Patent Application Publication
(10) Pub. No.: US 2014/0171036 A1
(43) Pub. Date: Jun. 19, 2014

(54) METHOD OF COMMUNICATION

(71) Applicant: Gwendolyn Simmons, Florissant, MO (US)

(72) Inventor: Gwendolyn Simmons, Florissant, MO (US)

(21) Appl. No.: 13/848,532

(22) Filed: Mar. 21, 2013

Related U.S. Application Data
(63) Continuation-in-part of application No. 12/621,097, filed on Nov. 18, 2009, now abandoned.

(51) Int. Cl. G09B 21/00; H04M 1/725

(52) U.S. Cl. CPC G09B 21/009; H04M 1/72591
USPC 455/414.1

(57) ABSTRACT

A method of communication using a software application or App with a communication device where the App is designed to perform real time communication between a hearing impaired person and a hearing person. The hearing person has a first communication device and the hearing impaired person has a second communication device. The App allows the hearing impaired person to utilize the device's camera, using his sign language, and translates his message to the device of the hearing person. The device of the hearing person translates his speech into sign language for the deaf person's device screen or monitor.

### CROSS-REFERENCE TO RELATED APPLICATIONS

This application is a continuation-in-part of U.S. patent application Ser. No. 12/621,097 filed on Nov. 18, 2009 which is hereby incorporated by reference.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to a method of communicating using software with an electronic device that enables the communication between a hearing impaired person and a hearing person.

2. Related Art

This invention relates to instantaneous communications between a hearing impaired (HI) person and a hearing (H) person even when they are remote from each other; and more particularly, to a method implemented using an application software, also known as an application or an App, designed to help the user to perform specific tasks. The software application App will perform specific tasks through devices with built-in cameras such as without limitation: a personal computer (PC), smart phones, iPad series, iPod series, iPhone 4 series, Android series, Tablet series, the Internet, Wireless, Bluetooth, and Infra-Red or Direct connection, etc., which will provide real time face-to-face two-way communications between a HI person and a H person even when they are remotely apart.

A method for achieving the performance of the software application App will consist of combining a variety of already established computer programs such as without limitation speak-to-text, speak-to-sign, sign-to-speak, sign-to-text, type and text-to-speak protocols integrated with the already established devices with built-in cameras, etc., which establish real time two-way communication between the HI person and H person, both in English as well as in other languages to translate between two languages.

In this digital age and age of communicating using a wide range of technologies, it is important to provide the hearing and deaf or hearing impaired individuals the capability of readily communicating with each other face-to-face and when they are physically located apart. Particularly, in the presence of a H person that doesn't know sign language and a HI person who is unable to communicate without an interpreter, it is desirable that the HI person have the opportunity to communicate in his own language, i.e., sign language. This can be obtainable through a software application App designed to utilize the built-in cameras of devices, that allows the HI person to sign into the camera of his device and the translation heard by the H person's device, without undue delay; and without the assistance of a third party mediator, such as a Telecommunications relay services (TRS) or Dual Party Relay Services (DRS). Also, with the assistance of the software application App, the H person will utilize his device by speaking into the camera of his device and the speech is converted into sign language and translated to the HI person's device. The appropriate sign language is visually displayed on a monitor or screen for the HI person to see in complete sentences or phases.

Conversely, it is desirable that the H person be able to immediately hear the sign language translated into speech from the HI person's device in complete sentences or phases. In this regard the HI person signs into the camera of his device and his/her message and corresponding to the message “speech” is heard from the H person's device and optionally, simultaneously texted words can also be displayed on the hearing person's his monitor or screen as the HI person signs into the camera what he wishes to communicate and thereby, converts into audio sounds and broadcast, optionally text as well, for the H person to see.

It is understood that devices that enable a HI person and a H person to communicate with each other currently exist. However, these devices have drawbacks. One such device, for example, is essentially only a dictionary that links to videos of a person signing words and letters on the screen of a device. It basically teaches a person how to sign words and letters. While useful in this regard, it does not enable direct, real time face-to-face conversations between a deaf person or hearing impaired person and a hearing person.

### SUMMARY OF THE INVENTION

The present invention is directed to a method of real time two-way communications between a hearing (H) person and a hearing impaired (HI) person. Each person utilizes a separate communication device. The communication device employed by the HI person has a built-in camera that he signs into, key pad, scroll lines, and a screen or monitor over which sign language is displayed. The communication device employed by the H person has a screen or monitor, scroll lines, key pad, built-in camera, built-in microphone, into which he speaks, and a speaker over which the sign language is converted to speech and is broadcast. When the H person speaks, the contents of his speech is converted into sign language and displayed on the HI person's monitor or screen. Optionally, his speech is also converted to text and displayed on the HI person's monitor. As the HI person signs into the camera of his device, the contents of that message is converted into speech, and broadcast for the H person to hear via his device where real time and face-to-face communication occurs in complete sentences or phases on each device.

It is a feature of the invention that the communication devices are portable or stationary with built-in cameras usable with the software application, App, design and the unique manipulation of some already established computer program integrations and can be used with a variety of communication vehicles including without limitation, a personal computer (PC), a smart phone, iPad series, iPhone 4 series, iPod 4 series, Android series, Tablet series, the Internet, Wireless, Bluetooth, and Infra-Red, etc.

Another feature of the invention is a method of the integration of already established computer programs and stored in the devices for its operation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings. The drawings constitute a part of this specification and include exemplary embodiments of the invention, which may be embodied in various forms. It is to be understood that in some instances, various aspects of the invention may be shown exaggerated or enlarged to facilitate an understanding of the invention; therefore the drawings are not necessarily to scale. In addition, in the embodiments depicted herein, like reference numerals in the various drawings refer to identical or near identical structural elements.

FIG. 1 illustrates an instantaneous conversation in real time two-way conversation between a hearing person and a hearing impaired person; and,

FIGS. 2a, 2b, 2c and 2d are a flowchart illustrating a method of two-way communications between a hearing person and a deaf person for real time face-to-face conversation.

### DETAILED DESCRIPTION OF THE PREFERRED EMBODIMENTS

The following description of the preferred embodiment(s) is merely exemplary in nature and is in no way intended to limit the invention, its application, or uses.

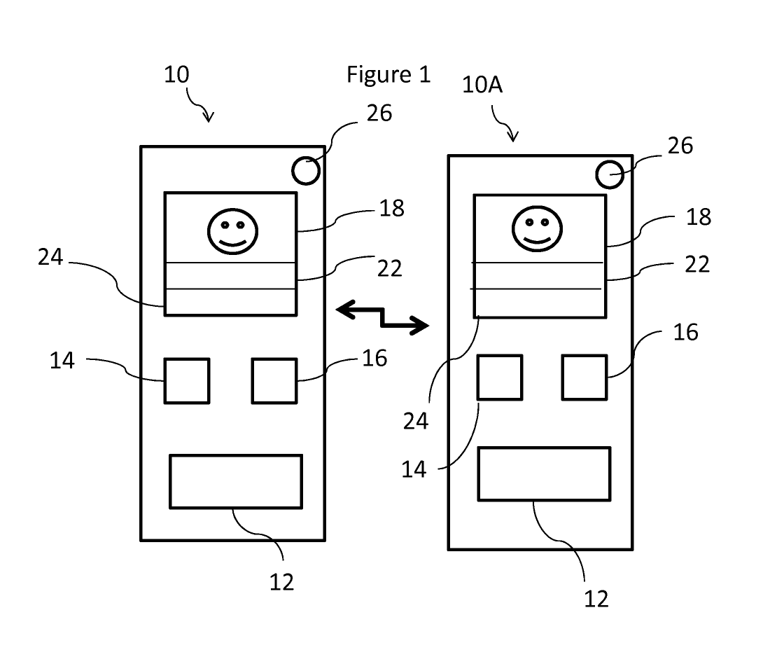

Referring to the drawings, the present invention is directed to a method by which a face-to-face real time two-way communications path is established between a hearing impaired (HI) person and a hearing (H) person enabling them to “talk” to each other particularly when they are face-to-face in real time conversation. As shown in FIG. 1, in one embodiment of the invention, the H person is equipped with a portable handheld first communication device 10 and the HI person is equipped with a second communication device 10A. Devices 10 and 10A are compatible in that they communicate with each other. Optionally, as shown in FIG. 1, devices 10 and 10A, are identical. Alternatively, the communication devices can be configured with the software application for exclusive use for a HI person and the other device for exclusive use for a H person. Each device 10 and 10A as shown in FIG. 1 includes a keyboard 12, a microphone (MIC) 14, a speaker (SPKR) 16, scroll lines 22, a monitor or screen 18 and camera (CAM) 26. It will be understood by those skilled in the art that the H person can use a headset with a built in microphone and speaker connected to the device for communicating with the HI person via built-in camera.

The devices 10 and 10A are capable of communicating with one another using a variety of already established technologies including without limitation: Internet, Wireless, Bluetooth, Infra-Red, a personal computer (PC), iPad series, iPhone 4 series, iPod 4 series, Android series, and Tablet series with built-in cameras, etc. The devices are also integrated with the already existing computer program enhancement of the speak-to-sign and sign-to-speak protocol with down loaded memory, a memory device such as a thumb drive or a memory stick and print features. As shown in FIG. 1, speak-to-sign appears and sign-to-speak in the center of screen 18 of the device. The figures/gestures can be either via a half body as shown in FIG. 1, full body animated, a virtual person, or signing hands. As noted above, use of speech recognition software and already established computer technologies enables spoken words to be converted to signs which are displayed through the animated half body, full body, virtual person, or signing hands feature on the device. In turn, the H person will hear aloud from their device what the HI person is communicating by signing into the camera 26 of his device, as well as having the ability to text his message. The message is displayed on the screens or monitors of the H person's device and broadcast from speaker 16 without assistance of third party Telecommunication relay services (TRS) or Dual Party Relay Services (DPRS).

The H person speaks into the built-in microphone 14 of the built-in camera 26 of his device 10. An electronics module (not shown) converts his speech into a digital electronic signal which is then transmitted from his device 10 to the device 10A being used by the HI person in sign language without assistance of third party Telecommunication relay services (TRS) or Dual Party Relay Services (DPRS). When the transmitted signal is received by the device 10A, an electronics module (not shown) of the device processes the signal and performs the following functions:

a) The signal is converted back into speech which can be broadcast through the speaker 16 of the communication device.

b) It determines which sign language signs stored in a look-up table of the device correspond to the speech.

c) It sequentially displays the signs on the monitor or screen corresponding to the sequence in which complete sentences, words or phrases are spoken or typed without third party assistance of Telecommunication relay services (TRS) and Dual Party Relay Services (DPRS).

d) Optionally, text scrolls across the bottom of the monitor representing the Sign language gestures/figures that are displayed on the monitor or screen.

With respect to the display, a FIG. 20 is displayed on the monitor and this figure “performs” the appropriate sign language corresponding to the received speech. Monitor 18 optionally includes a scroll line 22 which extends across the bottom of the screen.

When the HI person wishes to communicate, he can sign into the camera 26. The electronics module in his device 10A converts what has been signed into the camera into a digital electronic signal which is then transmitted from his device 10A to the device 10 being used by the H person. When the transmitted signal of sign language is received by the device 10, the electronics module in the device 10 processes the signal and performs the following functions:

a) The sign language signal is converted into audio sounds, i.e., speech, which is then broadcast through speaker 16 of the H person's device in complete sentences, words or phrases.

b) Optionally, the words are scrolled across the bottom of the monitor and the words are simultaneously broadcasted in complete sentences; words or phrases.

As with the device 10A, monitor 18 of the H person's device 10 also optionally includes a scroll line 22 which extends across the bottom of the screen. As the words are broadcast and simultaneously scrolled across line 22 without assistance of third party Telecommunication relay service (TRS) or Dual Party Relay Services (DPRS).

Those skilled in the art will recognize that devices 10 and 10A can be implemented in a variety of ways without departing from the scope of the invention. The device's computer program integration can be implemented using a personal computer (PC), and iPod series, iPhone 4 series, Android series, Tablet series with built-in cameras and the Internet, Wireless, Bluetooth, Infra-Red, an MP3 player and other types of personal digital assistant (PDA) devices.

It is a feature of the invention that the method allows the deaf person or hearing impaired or hearing person to communicate in their known native language understood by one another; which is then translated into a separate language which is understood by each. In accordance with the method of the invention, the language translations are available through existing computer programs for the operation of this function, for example, and without limitation, English, Spanish, French, German, Chinese, and Japanese. Beside an audio translation of these languages, they are also visually translated into sign language for the deaf, hard of hearing and hearing individuals. This facilitates, for example, instantaneous conversation in real time face-to-face communication for everyday travel and abroad without the use of third party assistance of Telecommunications relay services (TRS) or Dual Party Relay Services (DPRS).

Referring again to FIG. 1, in addition to the scroll line 22, devices 10 and 10A optionally include a second scroll line 24. When one language is translated into another, the language used by the HI person or H person is scrolled across one of the lines in that person's native language. The signing performed by the FIG. 20 on monitor 18 is in the language of the HI person using the device 10A; while the words broadcast from speaker 16 of the H person's device 10 is in the known language of that of the H person.

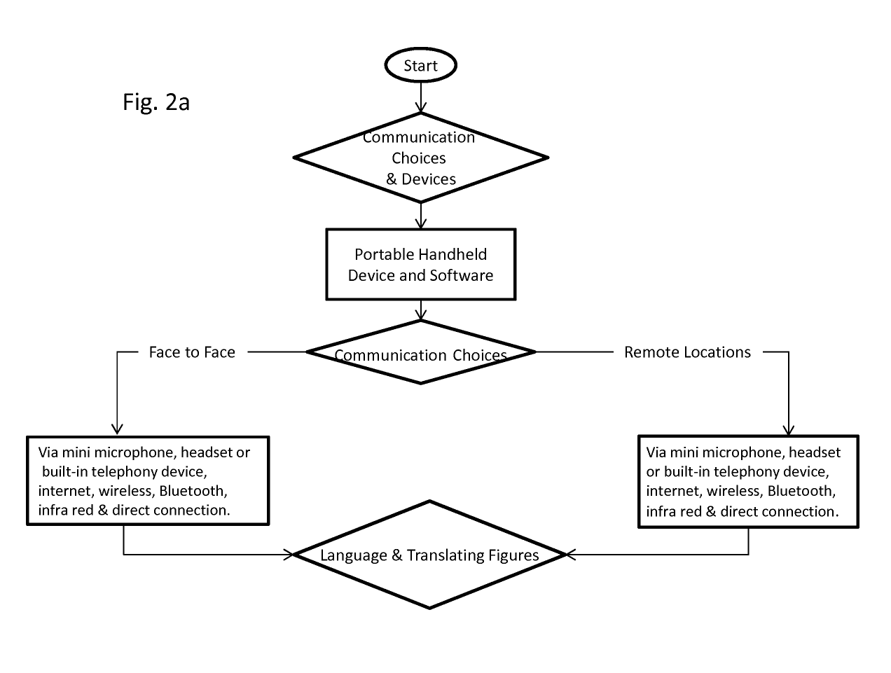

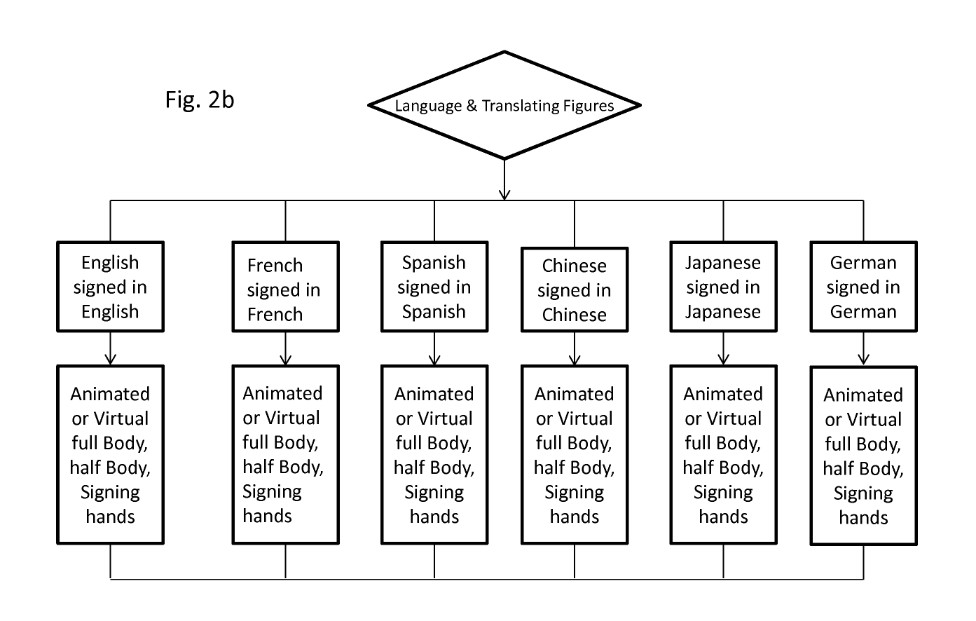

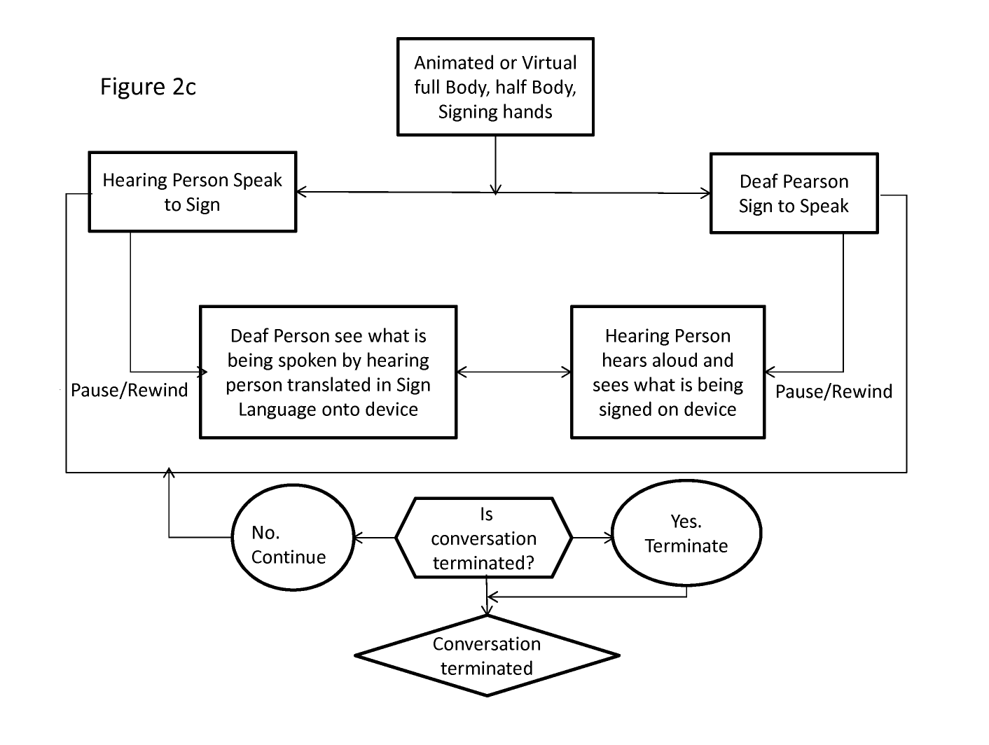

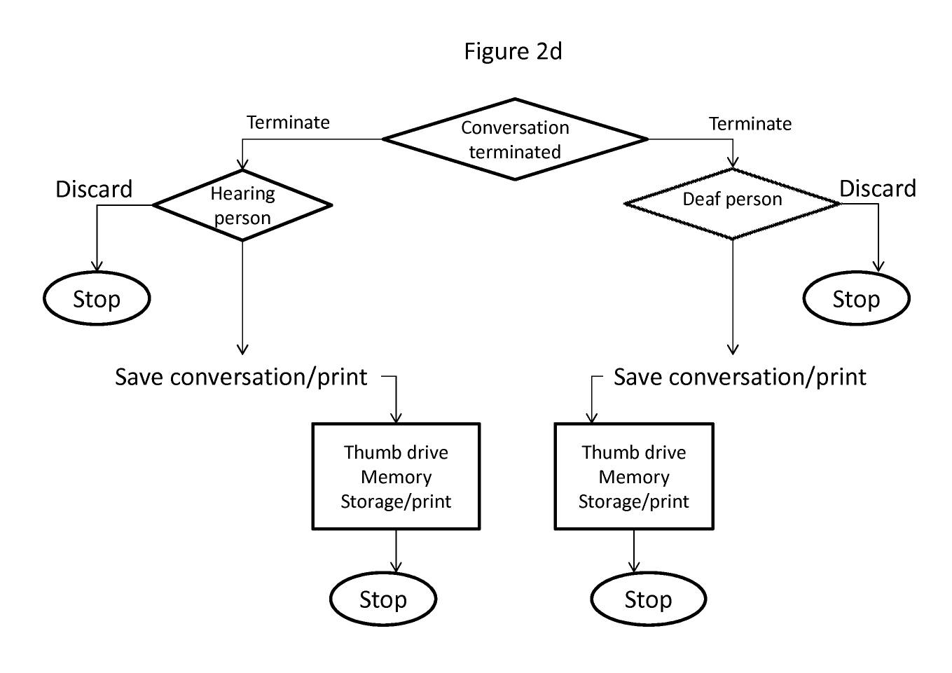

The flowchart of FIGS. 2a, 2b, 2c and 2d, illustrates the steps implemented in accordance with the method of the invention to incorporate the translation feature and other described features of the invention. As such, the integration of already existing computer programs needed for the functioning and operation of devices 10 and 10A will be achieved through the various processes shown in the flowchart of FIGS. 2a, 2b, 2c and 2d will be achieved through the incorporation of the devices 10 and 10A used by hearing and hearing impaired persons, respectively.

Finally, those skilled in the art will appreciate that a significant advantage of the invention is that it provides through the built-in camera features of handheld and stationary devices, instantaneous conversation in real time face-to-face communications between the H person and the HI person in a wide range of different settings; breaking the barrier of communication with different generations, the youth, adult and the senior people. The invention can also be used to build-up the confidence of poor spellers, and people who do not text or otherwise shy away from communicating with the deaf, because of lack of knowledge, education or computer technology skills.

In a preferred embodiment of the invention, the device will have two primary functionalities; sign language to audio translation for the HI person to communicate and audible language to sign translation for the hearing person to communicate. Communication will be virtually instantaneous with only enough delay to transmit the messages back and forth. Optionally, both translations can include translation to text.

Users of the app will be able to communicate face-to-face in the same location or remotely via the Internet. Optionally, the device will have the following features:

Sign language to text translation

Text to audio translation

Audio to text language translation

Text to sign language translation

Conversation recording feature

On-screen indicator light to indicate that the other person is still communication.

When a HI person signs into the camera, the app will capture video of the person using sign language. As communication is taking place, captions scroll at the bottom of the screen. The caption allows the HI person to see how accurately the message is being translated and even serve as a secondary mode of communication. By seeing the text captions, either party has the opportunity to clarify anything that was mistranslated.

The sign-to-text-to audio process, the following steps will take place:

User will sign in front of a device's camera.

As video is being captured the app will store each frame of video into a temporary session.

The app will scan each frame image for contrast and create vector coordinates that reflect the contrast around the hands, arms, and head.

The app will query the database for records where the coordinates of the temporary session closely match coordinates in the database.

When the app pulls enough sequential records to form letters, words, or phrases, that information will be compiled and sent as a message either in real time or manually by the user.

The text that is compiled will be simultaneously converted to audio using text to speech technology.

Using the same database, as a hearing person speaks into the device, a speech to text technology will be used to capture the message. The text will then be converted to visual sign language by referencing the stored images and text matches in the database.

When the user speaks and text is generated, the App will search the database (similar to a search engine) to find word matches. Once words or phrases are found, the corresponding still images will be compiled in sequence and broadcast to the hearing impaired person as video. The hearing person will be able to see the text captions (as will the hearing impaired person) to see if the message is being translated correctly.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of communicating between a hearing person who speaks and a hearing impaired person who uses sign language comprising:
providing a hearing person with a first communication device having a real time speak-to-sign software for translating speech into sign language;
providing a hearing impaired person with a second communication device having a real time sign-to-speak software for translating sign language into speech; and
wherein the first and second communication devices are compatible for communication;
and wherein the hearing person and hearing impaired person use the first and second communication device to communicate.

2. The method of claim 1 wherein the first and second communication devices are selected from the group consisting of a personal computer (PC), smart phone, iPod series, iPhone 4 series, Android series, Tablet series with built-in cameras and personal digital assistant (PDA) devices.

3. The method of claim 1 wherein the first communication device has a speaker, and wherein the second communication device has a display screen or monitor.

4. The method of claim 1, wherein the first and second communication devices have a camera.

5. The method of claim 1, wherein the first and second communication devices have a keyboard, a microphone, a speaker, a monitor and a camera.

6. The method of claim 5, wherein the first and second communication devices additionally have scroll lines.

7. The method of claim 1, wherein the first communication device also provides speech-to-text translation and the second communication device also provides sign-to-text translation.

8. A communication system for use between a hearing person who speaks and a hearing impaired person who uses sign language comprising:
a first communication device for use by a hearing person having a real time speak-to-sign software for translating speech into sign language;
a second communication device for use by a hearing impaired person having a real time sign-to-speak software for translating sign language into speech; and
wherein the first and second communication devices are compatible for communication.

9. The system of claim 8 wherein the first and second communication devices are selected from the group consisting of a personal computer (PC), smart phone, iPod series, iPhone 4 series, Android series, Tablet series with built-in cameras and personal digital assistant (PDA) devices.

10. The system of claim 8 wherein the first communication device has a speaker, and wherein the second communication device has a display screen or monitor.

11. The system of claim 8, wherein the first and second communication devices have a camera.

12. The system of claim 8, wherein the first and second communication devices have a keyboard, a microphone, a speaker, a monitor and a camera.

13. The system of claim 12, wherein the first and second communication devices additionally have scroll lines.

14. The system of claim 8, wherein the first communication device also provides speech-to-text translation and the second communication device also provides sign-to-text translation.

15. A method of communicating between a hearing person who speaks and a hearing impaired person who uses sign language using a software program comprising:
providing a hearing person with a first communication device having a real time sign-to-speak software for translating speech into sign language;
providing a hearing impaired person with a second communication device having a real time speak-to-sign software for translating sign language into speech; and
wherein the first and second communication devices are compatible for communication;
wherein the hearing person and hearing impaired person use the first and second communication device to communicate
wherein when the hearing person speaks, the software of the second communication device converts the speech to a signal, and the software provides the following steps:
a) the signal is converted back into speech
b) the speech is translated into sign language
c) the sign language is sequentially displayed on the monitor or screen corresponding to the sequence in which complete sentences, words or phrases; and
wherein the translation is made without third party assistance of Telecommunication relay services (TRS) and Dual Party Relay Services (DPRS).

16. The method of claim 15, wherein when the hearing impaired person uses sign language, the first communication device converts the sign language into a signal, and the software translates the signal into words or speech.

17. The method of claim 16 wherein the first and second communication devices are selected from the group consisting of a personal computer (PC), smart phone, iPod series, iPhone 4 series, Android series, Tablet series with built-in cameras and personal digital assistant (PDA) devices.

18. The method of claim 16, wherein the first and second communication devices have a keyboard, a microphone, a speaker, a monitor and a camera.

19. The method of claim 18, wherein the first and second communication devices additionally have scroll lines.

20. The method of claim 16, wherein the first communication device also provides speech-to-text translation and the second communication device also provides sign-to-text translation.
